(19) United States
(12) Patent Application Publication
(10) Pub. No.: US 2016/0028472 A1
(43) Pub. Date: Jan. 28, 2016

(54) METHOD AND SYSTEM FOR DYNAMIC SHARING OF SATELLITE BANDWIDTH BY MULTIPLE SITES WITH CONCURRENT TERRESTRIAL TRANSMISSION

(71) Applicant: INTELSAT CORPORATION, Washigton, DC (US)

(72) Inventor: Luis VALENCIA, Bethesda, MD (US)

(73) Assignee: INTELSAT CORPORATION, Washington, DC (US)

(21) Appl. No.: 14/774,034

(22) PCT Filed: Mar. 20, 2014
(86) PCT No.: PCT/US14/31296

§ 371 Date: Sep. 9, 2015

Related U.S. Application Data
(60) Provisional application No. 61/804,481, filed on Mar. 22, 2013.

(51) Int. Cl. H04B 7/185; H04W 28/20

(52) U.S. Cl. CPC H04B 7/18513; H04B 7/18563; H04W 28/20; H04W 84/06

(57) ABSTRACT

A method of transmitting bursty data and non-bursty data, the method including using terrestrial networks to transmit the non-bursty data and sharing satellite bandwidth to transmit the bursty data from multiple sites. The non-bursty data and the bursty data are transmitted concurrently via the terrestrial networks and the satellite bandwidth, respectively. The bursty data is non-voice data with bursty characteristics.

### RELATED APPLICATIONS

This application claims priority from U.S. Provisional Patent Application No. 61/804,481, filed on Mar. 22, 2013, in the United States Patent and Trademark Office, the disclosure of which is hereby incorporated herein in its entirety by reference.

### BACKGROUND

1. Technical Field

Systems and methods consistent with the present invention generally relate to the dynamic sharing of satellite bandwidth by bursty data traffic from multiple sites while concurrently transmitting other non-bursty traffic, including voice, terrestrially.

2. Description of the Related Art

Telecommunications networks have been evolving to carry growing data traffic to complement voice traffic for which these networks were initially designed. Voice traffic and associated voice services have been supported using circuit switched architectures, where physical circuits are assigned at the initiation and taken down at the termination of a call. Circuit switching has been an effective solution to support voice, because conversational voice has real time requirements. That is, voice needs to be transmitted within fairly tight time constraints, and it needs specifically assigned capacity in the network.

Data, however, especially data used by consumers through personal devices, has bursty characteristics and does not have the same real time requirements as voice transmission. Traffic is bursty when it is transmitted in short, uneven spurts (bursts). Internet traffic is generally bursty because it is driven by human action—browsing the web, sending an email, etc. These human actions take place in an instant. When the information is transmitted and delivered the link becomes idle while the user reviews or reads the information received. Because of these characteristics, most of the data traffic today is transmitted using packet protocols. Packet protocols allow more efficient use of telecommunications channels' bandwidth by loading transmission channels with packets from different users and applications to the extent possible.

Telecommunications network owners or operators upgrade their networks to support the new data requirements by adding bandwidth to existing links. The amount of added bandwidth provisioned to support bursty data is generally the peak traffic expected to and from each network site. The load of these traffic peaks is generally several times the average traffic load of the site.

Therefore, voice and data networks are generally designed with a combination of dedicated capacity for circuit switched voice traffic, and capacity based on peak traffic requirements for data traffic.

In particular, in related art cellular networks, communication-related data including voice data and non-voice data is transmitted between a Mobile Telephone Switching Office—MTSO (center of cellular network, via which the communication data is routed) and cell sites (e.g., base stations, to which mobile devices are connected via the radio access network). A common architecture found in related art cellular networks is shown in FIG. 1. In this architecture, traffic from cell sites is connected to the network core through several layers of aggregation and daisy chain connections. The connection from the outer cell sites to the aggregation points is generally provided using point-to-point links.

The growth in data traffic requires cellular operators to support several times the bandwidth in links from cell sites to the MTSO when evolving from voice dominant services supported by second generation (2G) technologies to data dominant services supported by third generation (3G) technologies.

3G systems continue to support voice with a circuit switched approach, while breaking up the data into data packets for more efficient transmission. Packetizing data permits a higher utilization of the bandwidth available by loading channels with packets from different applications and users to the extent possible. Cellular operators normally combine voice and data traffic into a single stream for transmission between cell sites and the MTSO.

### SUMMARY

A network designed to support peaks causes the network to have significant idle capacity when those peaks are not taking place. That is, when point-to-point terrestrial links are used to connect locations to support voice and bursty data traffic simultaneously, these links are sized in a way that creates significant idle capacity. In a cellular network, for example, the average traffic load for data is several times smaller than the peak traffic load for which it is designed.

When point-to-point microwaves are used to connect these cell sites to the MTSO, the addition of third generation (3G) data services with its increase in bandwidth requirements may require swapping equipment at multiple points in the network and expanding capacity on those microwave links. The extent of the network changes depends on the current architecture. The increase of capacity in microwave links for traffic close to the edge of the network may be trivial in some cases. However, significant capacity increases close to the network core may require extensive changes and additions to the network.

In a mobile network, the backhaul capacity to each cell site is sized to support the peak traffic from that cell site. FIG. 2 shows a traffic plot from a related art cell site over a period of 3 days. The traffic peaks do not occur frequently and only occur for relatively short periods. Typical data traffic has an average utilization of less than 25% of the backhaul capacity. Traffic peaks from different cell sites are not correlated. That is, it is highly unlikely that such traffic peaks from different cell sites will occur at the same time. As such, in a typical network, there is significant idle capacity when the traffic is not at the infrequent peaks.

When traffic is bursty and traffic peaks from multiple sites do not happen at the same time, the capacity sharing capability of satellites can be used to efficiently and effectively transport this traffic, as discussed below.

One of the inherent characteristics of satellites is the ability to connect geographically dispersed locations within a coverage defined by the satellite beam or footprint. Satellite technology enables two or more geographically dispersed locations in need of connectivity at different times to share a communication resource. If the traffic from these sites is bursty and the traffic peaks do not happen at the same time, a higher level of utilization and efficiency can be achieved in transporting this traffic using satellites when compared with terrestrial point-to-point networks.

When a network needs to simultaneously support bursty data and other applications, such as voice, that require dedicated circuit connectivity, concurrent use of terrestrial links with shared satellite networks offers a very effective solution.

Therefore, one of the objectives of the present application is to introduce methods and systems for using a satellite as an intermediary between the center or core of the network and the sites at the edge of the network to minimize the strain on backbone networks when transitioning from an architecture designed to transmit voice dominant data to an architecture designed to transmit non-voice dominant data (e.g., multimedia data).

Accordingly, a non-limiting embodiment provides a method of transmitting bursty data and non-bursty data, the method including using terrestrial networks to transmit the non-bursty data and sharing satellite bandwidth to transmit the bursty data from multiple sites.

The non-bursty data and the bursty data may be transmitted concurrently via the terrestrial networks and the satellite bandwidth, respectively.

The bursty data is non-voice data with bursty characteristics.

The sharing the satellite bandwidth may include dynamically sharing the satellite bandwidth to transmit the bursty data from the multiple sites using a demand assigned technique.

Using the demand assigned technique may include assigning time slots and/or frequency bands in the satellite bandwidth to the multiple sites for transmitting the bursty data using the satellite bandwidth.

The demand assigned technique may further include adjusting the time slot and/or frequency band in the satellite bandwidth assigned to a cell site, from among the multiple sites, in response to traffic needs of the cell site.

The method may further include separating, using a controller at each respective site, the bursty data and the non-bursty data for transmission terrestrially and by satellite, respectively.

Another non-limiting embodiment provides an apparatus for transmitting bursty data and non-bursty data, the apparatus including one or more processors configured to use terrestrial networks to transmit the non-bursty data, and share satellite bandwidth to transmit the bursty data from multiple sites.

The one or more processors may be further configured to transmit the non-bursty data and the bursty data concurrently via the terrestrial networks and the satellite bandwidth, respectively.

The bursty data may be non-voice data with bursty characteristics.

The one or more processors may be configured to share the satellite bandwidth by dynamically sharing the satellite bandwidth to transmit the bursty data from the multiple sites using a demand assigned technique.

The demand assigned technique may include assignment of time slots and/or frequency bands in the satellite bandwidth to the multiple sites for transmitting the bursty data using the satellite bandwidth.

The demand assigned technique may further include adjustment of the time slot and/or frequency band in the satellite bandwidth assigned to a cell site, from among the multiple sites, in response to traffic needs of the cell site.

The apparatus may further include a controller at each site which separates the bursty data and the non-bursty data for transmission terrestrially and by satellite, respectively.

### BRIEF DESCRIPTION OF THE DRAWINGS

The above and other features and advantages of the present invention will become more apparent by describing in detail exemplary embodiments thereof with reference to the attached drawings in which:

FIG. 1 shows a related art cellular network architecture;

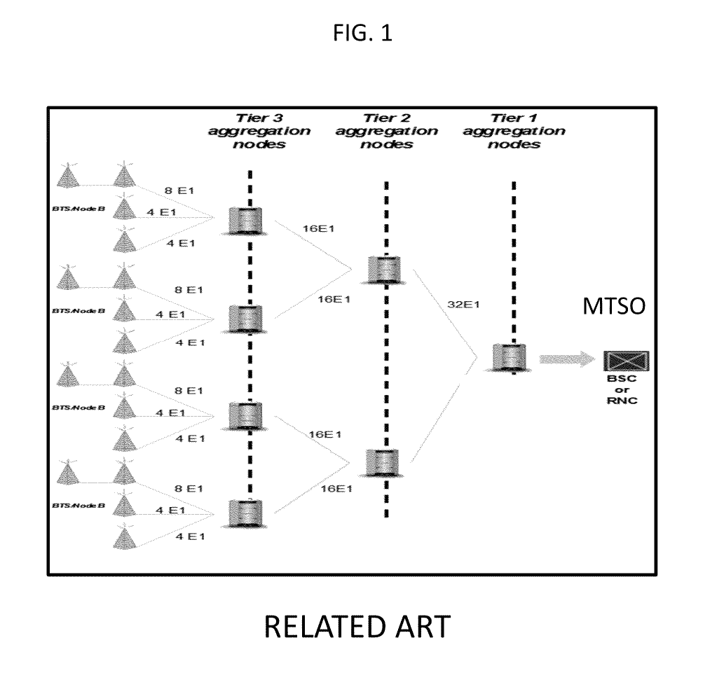

FIG. 2 shows a traffic plot from a related art third generation (3G) cell site over a period of three days;

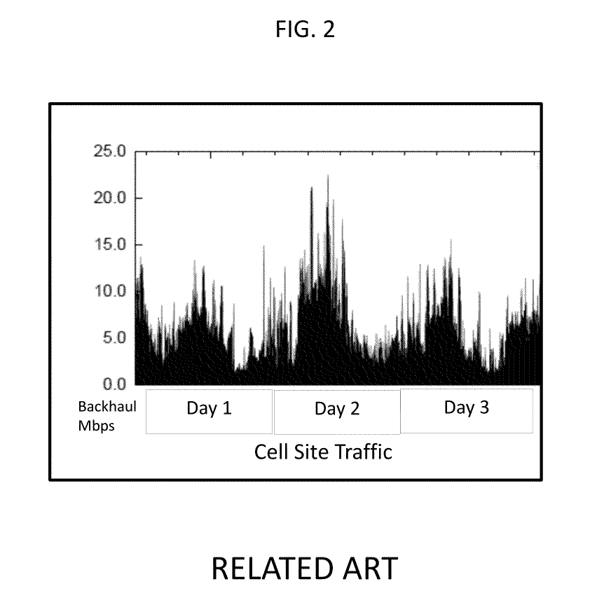

FIG. 3 shows a mobile data overlay system, according to an exemplary embodiment of the present invention;

FIG. 4 shows a data transmission mechanism in a related art cellular network; and

FIG. 5 shows a mobile data overlay with data offload architecture, according to an exemplary embodiment of the present invention.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

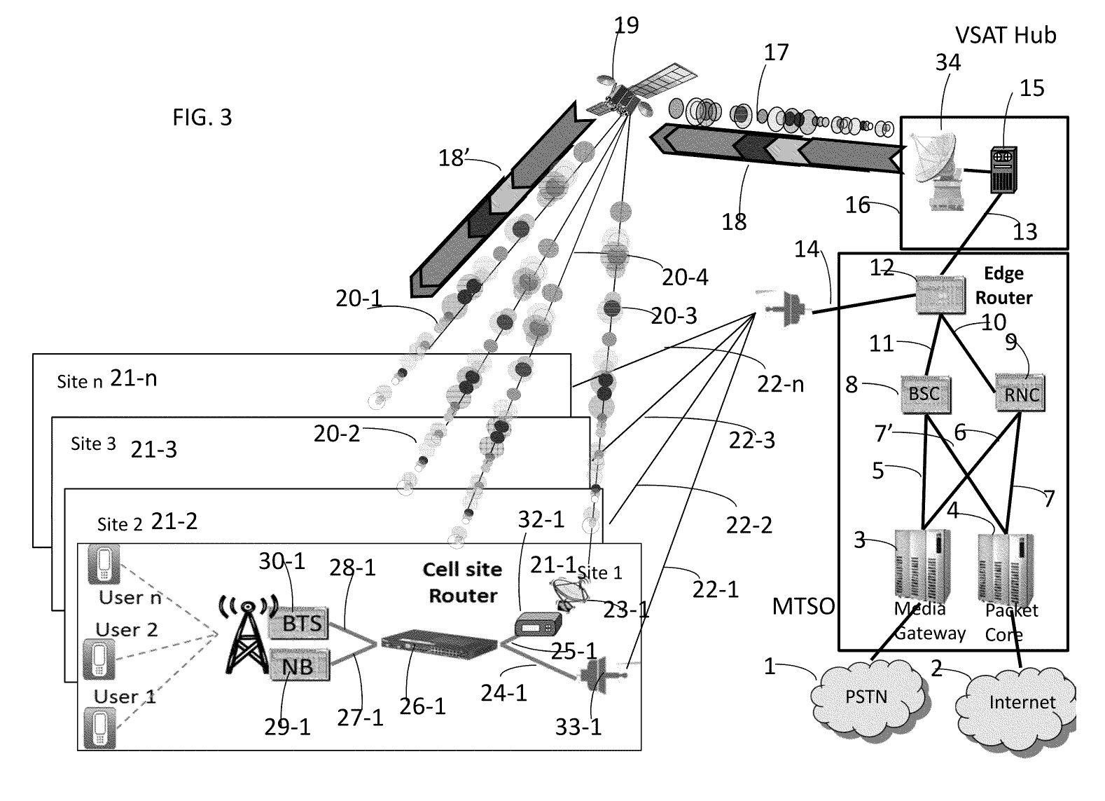

In one non-limiting embodiment illustrated in FIG. 3, voice data and non-voice data are separated so both can be effectively and efficiently transmitted over terrestrial and satellite links, respectively. Data traffic in cellular networks is primarily driven by users accessing the internet. Accordingly, this traffic is very bursty. Data traffic from multiple sites 21-1 to 21-n share satellite bandwidth to make efficient use of the bandwidth by allowing the use of transmission idle times between traffic peaks. Data traffic separation and individual treatment this way proves to be advantageous based on both performance and financial metrics.

Satellites are currently used in cellular networks to transmit voice data only or combined voice and non-voice data, but are not currently used to concurrently share satellite capacity to transmit data from multiple sites while transmitting voice traffic from those sites using terrestrial networks.

In the non-limiting embodiment, the voice and non-voice data traffic for a cellular network can be transmitted concurrently using terrestrial (microwave, fiber), as well as satellite links. Voice data is transmitted effectively and with optimal performance using terrestrial links, while bursty non-voice data is transmitted efficiently and effectively by sharing bandwidth to support data streams from multiple cell sites over a satellite network.

Satellite networks provide an optimal solution for transmission of data in cellular networks. Since cell site traffic peaks are not correlated, the shared satellite bandwidth does not have to be sized to support the sum of the traffic peaks for all sites, but a fraction of this sum. Sharing a pool of satellite bandwidth by many sites in a dynamic manner increases bandwidth efficiency many-fold. Data is transmitted from cell sites to the satellite only when there is data activity. When two or more cell sites have data traffic to transmit at the same time, the satellite network acts as a traffic controller controlling the flow of traffic by introducing minimal delays to some of the traffic in a manner similar to traffic lights at the entrance to a highway.

In the non-limiting embodiment as shown in FIG. 3, a system (e.g., a Mobile Data Overlay system) includes equipment that connects the packetized non-voice data traffic to the MTSO using a satellite link, while keeping the voice data traffic on existing point-to-point terrestrial links 22-1 to 22-n. A cell site router 26 (e.g., 26-1 shown in FIG. 3) at the cell sites is used to separate the voice and non-voice data traffic for concurrent transmission via terrestrial and satellite links, respectively. This cell site router 26 could also be used to connect the signaling (control) traffic from the cell site to the terrestrial link if that proves beneficial. The cell site router is sometimes integral part of the Node B (NB) 29-1.

An alternative way of separating voice from data traffic in a cell site that supports both 2G and 3G traffic is to use a centrally controlled configuration called 2G Voice Fallback. When this configuration is used, all voice calls originating from subscribers in the coverage area of the cell site are “forced” to use the 2G base station (BTS). When using this configuration, the 3G Node B would not see any voice traffic, and its output towards the backhaul would consist of only data traffic. Therefore, the output of the of the 2G BTS would continue to be connected to the terrestrial link, while the output of the 3G Node B would be connected directly to the satellite link. In this mode, the cell site router would not be required. Another variation of the 2G Voice Fallback mode is where the user data traffic is separated from the control or signaling traffic so that the user data traffic can be transported by satellite and the control traffic can be transported terrestrially along with the voice traffic. In this variation, the separation of the user data and control traffic is performed through the cell site router 26. The aggregation of the control and voice traffic for transmission terrestrially is also performed by the cell site router. In yet another variation of the non-limiting embodiment, the cell site router 26 and the corresponding edge router 12 could be equipped to detect user data applications whose performance is negatively affected by high latency channel, such as gaming. Those data applications would be connected to the terrestrial link, while the rest of the data applications are transported by satellite.

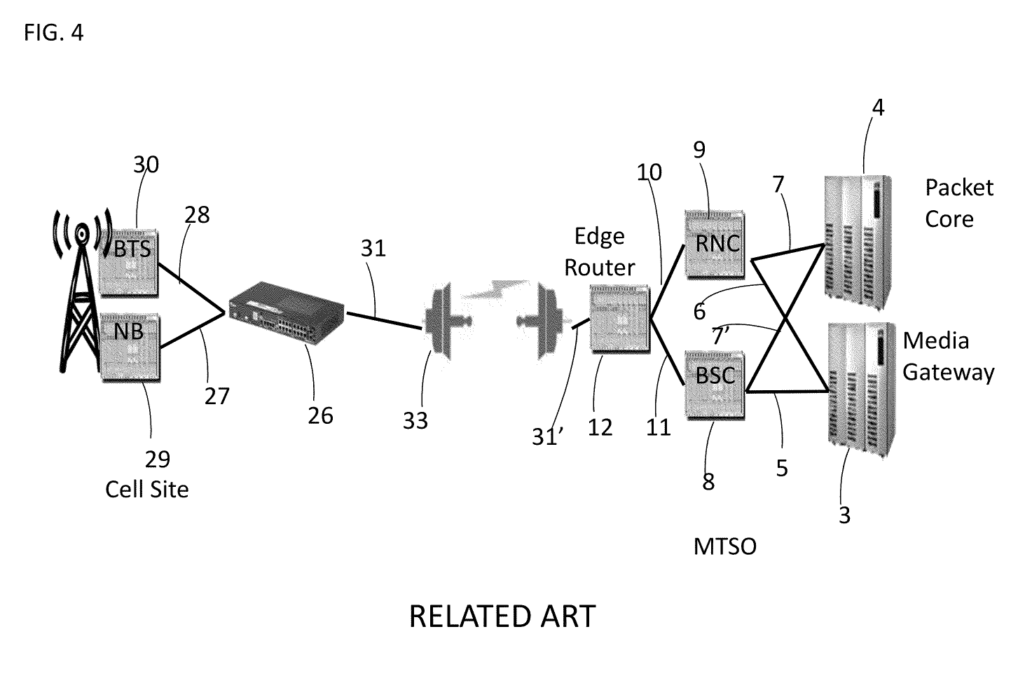

In a related art cellular network served by point-to-point microwave as shown in FIG. 4, 2G and 3G systems are collocated at each cell site, and voice and data traffic 28 from the 2G base station (BTS) 30 is aggregated with the voice and data traffic 27 from the 3G Node B 29. The 2G traffic 28 uses Time Division Multiplex (TDM) protocol for backhaul transmission and the 3G traffic 27 uses either Asynchronous Transfer Mode (ATM) or Internet Protocol (IP) for backhaul transmission. The aggregated traffic 31 uses either ATM or IP, depending on the configuration of the Radio Network Controller (RNC) 9 located at the MTSO or some intermediate switching facility. TDM protocol consists of circuits with dedicated bandwidth, regardless of the presence of actual information-bearing traffic, while ATM and IP protocols use frames (fixed size frames called ‘cells’ for ATM and variable sized frames called ‘packets’ for IP), which provide the option for transmission only when information-bearing traffic is present.

At the cell site, in order to accommodate the various technologies and protocols of multi-generational cellular systems and multi-generational backhaul systems, a cell site router 26 is typically installed to provide the appropriate interfaces for the BTS 30 and Node B 29 and then aggregate the traffic under a common protocol to generate aggregated signal 31. In those areas that are served by TDM microwave backhaul solutions, the cell site router 26 may aggregate the traffic using ATM or IP, but then it converts or encapsulates the traffic for transmission over one or more TDM circuits. There are also backhaul solutions that include both TDM and Ethernet circuits in parallel.

At the MTSO, the aggregated signal 31′ is typically received after transmission over the backhaul infrastructure (including the microwave equipment 33) using an edge router 12. These devices function to reconvert and disaggregate the transmissions from the cell sites to their original protocols and then direct the 2G traffic 11 from multiple BTSs 30 to the 2G Base Station Controller (BSC) 8 and the 3G traffic 10 from multiple Nodes B 29 to the Radio Network Controller (RNC) 9. From the BSC 8 and RNC 9, the voice traffic 5 and 6 is connected to the Media Gateway 3 and the data traffic 7 and 7′ to the Packet Core 4, both part of the cellular operator's core, before connection to the Public Switched Telephone Network (PSTN) 1 and the Internet 2, respectively.

In the cellular network architecture disclosed in the non-limiting embodiment a cell site router 26 is interposed between the 2G BTS 30 and 3G Node B 29 equipment and the microwave equipment 33 at each cell site 21. This cell site router 26 aggregates the traffic streams 27 and 28 from both the BTS 30 and the Node B 29, and separates the voice 24 and data 25 traffic for transmission terrestrially and by satellite, respectively. Terrestrial transmission carries voice traffic using tiered point-to-point networks. Data traffic from multiple cell sites 21-1 to 21-n shares satellite bandwidth as detailed below. At the MTSO, the traffic streams from the microwave links 14 and satellite links 13 originating at multiple sites are connected to an edge router 12, which reconverts and disaggregates the transmissions from the cell sites to their original protocols and then direct the 2G traffic from multiple BTSs 11 to the 2G Base Station Controller (BSC) 8 and the 3G traffic from multiple Node Bs 10 to the Radio Network Controller (RNC) 9. The BSC 8 connects the voice traffic 5 to the Media Gateway 3 and 2G data traffic 7′ to the Packet Core 4. The RNC 9 separates the voice 6 and data traffic 7 streams and connects them to the Media Gateway 3 and the Packet Core 4, respectively. The traffic separation for long distance transmission (backhaul) and sharing of bandwidth by multiple cell sites allows individual treatment of the traffic, proving to be advantageous for both performance and financial metrics.

The separation of traffic for backhaul transmission is performed in a similar manner when using ATM or IP protocol. When using ATM, the cell site router 26 looks for specific virtual circuits designated by the Node B 29 to carry data, and directs this data to the satellite link. Because the satellite system uses IP protocol, the cell site router 26 encapsulates the ATM traffic into an IP stream for transparent satellite transmission. When using IP protocol, the cell site router 26 makes use of the Differentiated Services Code Point (DSCP) settings to determine which packets contain data so that it can direct them to the satellite link.

As discussed above, although satellites have been used to transmit voice data and combination of voice data and non-voice data, they have not been used as a parallel transmission media to carry data from multiple sites sharing the same bandwidth, while voice data from the same cell sites is transmitted via terrestrial links. Satellites are generally used in cellular networks when no other transmission media is available or economical. This criterion limits the use of satellites in cellular networks for transmission to and from remote locations. Considering the general unavailability of other transmission media to these remote locations, there have not been opportunities to use terrestrial and satellite links concurrently to support traffic from cell sites. There are instances where satellites are used to provide backup to high value links in networks. In a backup mode, the satellite link is generally idle and only used when the terrestrial link is unavailable. Thus, the functionality and outcome when satellites are used for backup is very different from the functionality and outcome when satellites are used concurrently with terrestrial links to optimize performance.

Specifically for the solution in the non-limiting embodiment, transmission via a satellite 19 is carried out by using a statistical multiplexing technique called Demand Assigned Multiple Access (DAMA) for transmission from the cell sites 21-1 to 21-n to the VSAT hub 16 (inbound).

DAMA is a method used to enable multiple earth stations or VSAT terminals 23-1 to 23-n to transmit intermittently sharing a same frequency band, but with the timing and or frequency of their transmissions so arranged that they do not overlap when they arrive at the satellite 19 so that all are successfully received by the network hub 16.

The operation of DAMA requires an outbound signal 18, which carries control information to all the remote sites for them to share the satellite bandwidth assigned for inbound traffic. This outbound carrier 18 also provides timing information for all the remote sites. The hub 16 tells each VSAT 23 what particular time slot and/or frequency band to use for transmission from the VSAT 23 to the hub 16. The allocation of inbound capacity may be fixed, so as to allocate each site a particular proportion of the total DAMA capacity pool or it may be dynamic, whereby the capacity allocation is adjusted in response to the traffic needs of each site. Current systems allow the hub 16 to temporarily allocate dedicated capacity within the inbound channel 17 to a VSAT when high volume of traffic needs to be transmitted. This capacity is dynamically sized and assigned by the system based on the traffic demand communicated by the VSAT to the hub.

The earth stations of a VSAT network communicate via the satellite by means of modulated carriers. Any such carrier is assigned a portion of the resource offered by the satellite in terms of power and bandwidth. This assignment can be a ‘fixed assignment’ (FA), or based on requests from the VSATs depending on the traffic they need to transmit (‘demand assignment’ (DA)).

In a fixed assignment network, the satellite resource is shared in a fixed manner by all stations whatever the traffic demand may be. If in a given instant the VSAT traffic load is larger than that which can be accommodated by capacity allocated to that VSAT as determined by its share of the satellite resource, the VSAT must store or reject the traffic. This situation either increases traffic delay or introduces blocking of traffic, and can also take place even when some VSATs do not have any traffic to transmit, causing the network not to be optimally exploited.

With demand assignment, VSATs share a variable portion of the overall satellite resource. VSATs use only the capacity which is required by their users, and leave the capacity in excess for use by other VSATs as depicted in FIG. 3. This variable sharing can be exercised only within the limits of the total satellite capacity allocated to the network. Demand assignment is performed by means of requests for capacity transmitted by individual VSATs 23-1 to 23-n. Those requests are transmitted to the traffic control (hub) station 16. The hub station 16 replies by allocating to the VSAT 23 the appropriate resource, either a frequency band or a time slot. With distributed management, all VSATs keep a record of occupied and available resource. A demand assigned network offers a better use of the satellite resource but at the expense of a slightly higher delay in connection set-up.

From the MTSO to the cell sites 21 (outbound), a broadcast signal 18 and 18′ is transmitted by the hub 16 and received by all VSATs 23-1 to 23-n in the network. For the inbound traffic 20-1 to 20-n, each VSAT 23-1 to 23-n is given access to the satellite 19 when the subject VSAT needs to transmit. For the outbound traffic 18 and 18′, capacity is assigned dynamically on the broadcast signal to each cell site based on the traffic requirements to those cell sites. Both the inbound and outbound transmission techniques are very efficient for sharing the network among multiple sites with bursty data traffic.

The satellite network (VSAT network) typically consists of a hub earth station 16 connected to the operator's network core, and a number of VSAT earth stations 23-1 to 23-n connected to cell site routers 26-1 to 26-n at cell sites 21-1 to 21-n. The non-limiting embodiment shown in FIG. 3 includes a typical VSAT network. The network hub 16 consists of a Traffic Processor and Network Manager 15 collocated with a hub antenna 34. The hub antenna 34 is typically larger than the antennas located at the cell sites. The hub transmits a signal 18 that carries traffic for all the VSATs in the network in a broadcast manner. The Traffic Processor and Network Manager 15 assigns capacity on the broadcast signal 18 to traffic destined to each VSAT based on requests for capacity from the cell sites 21. At each site there is a Very Small Aperture Terminal (VSAT) 23 that consists of a small antenna with radio frequency (RF) terminal and an indoor unit that processes traffic (router/modem) 32 (32-1 to 32-n). There are several manufacturers of satellite equipment that use Demand Assigned Multiple Access. Among them are Hughes Network Systems, iDirect Technologies, Comtech EF Data, Newtec and Gilat Satellite Networks.

Sharing of satellite bandwidth by multiple cell sites using DAMA reduces the amount of capacity required to support the network to a small fraction of the bandwidth that would be assigned to carry the same traffic using the existing related art point-to-point terrestrial or satellite facilities designed to support traffic peaks from cell sites. For example, in a 100 cell site network, if each cell site requires 16 Mbps of transmission capacity to support non-voice data traffic, the total network capacity required to support all 100 sites would be 1.6 Gbps in both directions, inbound and outbound, in the related art cellular network architecture. With a bandwidth sharing rate of 10 to 1 over the system disclosed in the non-limiting embodiment using satellites to transmit non-voice data, and asymmetry of 4 to 1, meaning that the outbound traffic is four times the inbound traffic, the satellite bandwidth required would only be a little more than 160 Mbps for the outbound traffic and a little more than 40 Mbps for the inbound traffic.

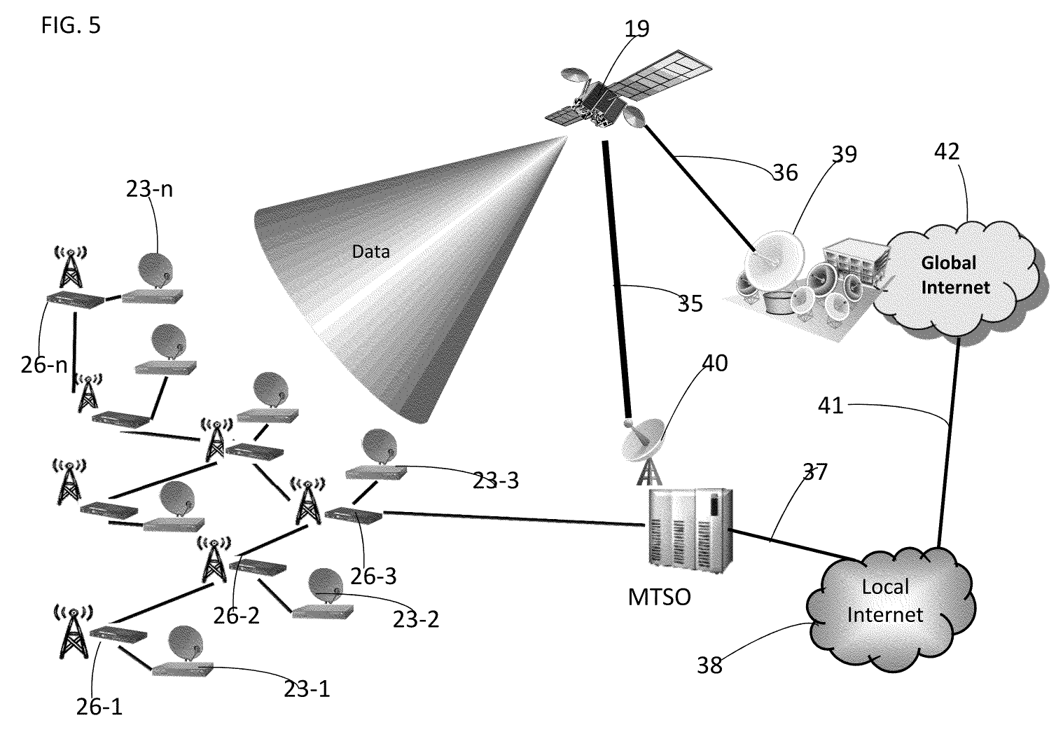

In another non-limiting embodiment shown in FIG. 5, a Mobile Data Overlay with Data Offload system is disclosed—the Mobile Data Overlay with Data Offload system separates the voice traffic from the non-voice data traffic as described above with respect to FIG. 3, and further separates data based on its destination. Data 35 destined to a location in proximity to the network core is transmitted to the MTSO as in the systems described with respect to FIG. 3, while data 36 that is destined to a location that is geographically far from the MTSO is transmitted directly to that location via the same satellite 19. As shown in FIG. 5, traffic 35 destined to the local Internet 38 is routed via satellite 19 to the MTSO and from there to the local Internet via traffic signal 37, while the traffic 36 destined to the global Internet 42 (e.g., located in another country or another continent, as the case may be in developing countries) is transmitted directly via the same satellite 19 without going through the MTSO. This separation of the traffic is accomplished using the same equipment as described with respect to FIG. 3. The cell site router 26 determines the destination of the traffic (e.g., based on IP addresses), and directs the packets on two different satellite bearers 35 and 36 that are received at the two different locations 39 and 40. Data traffic from multiple cell sites destined to the distant location also uses the bandwidth sharing method to optimize the use of bandwidth.

The two data streams 35 and 36 are therefore connected to the local Internet 38 and global 42 Internet, respectively, without the use of long distance terrestrial extensions. Only voice traffic uses terrestrial links. When the global Internet 42 is located in another country, or even in another continent, as depicted in the current embodiment, long distance fiber facilities 41 between the MTSO and the global Internet 42 are no longer needed to support the data traffic for the subject cell sites, eliminating the cost of those fiber facilities.

For example, in the 100 cell site network case described earlier, if 50% of the data traffic from the cell sites terminates in another country or continent, the system described in the current embodiment with respect to FIG. 5 reduces the requirement for fiber connectivity by 80 Mbps.

The system described in the current embodiment is particularly effective when its implementation can be accomplished with a single VSAT at cell sites, and in situations where the connectivity to another country or continent can be implemented without increasing the size of the antenna or radio frequency (RF) equipment, which would increase the cost of each VSAT.

At least certain principles of the invention described above by way of non-limiting embodiments can be implemented as hardware, firmware, software or any combination thereof. Moreover, the software is preferably implemented as an application program tangibly embodied on a program storage unit, a non-transitory user machine readable medium, or a non-transitory machine-readable storage medium that can be in a form of a digital circuit, an analogy circuit, a magnetic medium, or combination thereof. The application program may be uploaded to, and executed by, a machine comprising any suitable architecture. Preferably, the machine is implemented on a user machine platform having hardware such as one or more central processing units (“CPUs”), a memory, and input/output interfaces. The user machine platform may also include an operating system and microinstruction code. The various processes and functions described herein may be either part of the microinstruction code or part of the application program, or any combination thereof, which may be executed by a CPU, whether or not such user machine or processor is explicitly shown. In addition, various other peripheral units may be connected to the user machine platform such as an additional data storage unit and a printing unit.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A method of transmitting bursty data and non-bursty data, comprising:
using terrestrial networks to transmit the non-bursty data; and
sharing satellite bandwidth to transmit the bursty data from multiple sites.

2. The method of claim 1, wherein the non-bursty data and the bursty data are transmitted concurrently via the terrestrial networks and the satellite bandwidth, respectively.

3. The method of claim 2, wherein the bursty data is non-voice data with bursty characteristics.

4. The method of claim 2, wherein the sharing the satellite bandwidth comprises dynamically sharing the satellite bandwidth to transmit the bursty data from the multiple sites using a demand assigned technique.

5. The method of claim 4, wherein using the demand assigned technique includes assigning time slots and/or frequency bands in the satellite bandwidth to the multiple sites for transmitting the bursty data using the satellite bandwidth.

6. The method of claim 5, wherein the demand assigned technique further includes adjusting the time slot and/or frequency band in the satellite bandwidth assigned to a cell site, from among the multiple sites, in response to traffic needs of the cell site.

7. The method of claim 1, further comprising:
separating, using a controller at each respective site, the bursty data and the non-bursty data for transmission terrestrially and by satellite, respectively.

8. An apparatus for transmitting bursty data and non-bursty data, comprising:
one or more processors configured to:
use terrestrial networks to transmit the non-bursty data; and
share satellite bandwidth to transmit the bursty data from multiple sites.

9. The apparatus of claim 8, wherein the one or more processors are configured to transmit the non-bursty data and the bursty data concurrently via the terrestrial networks and the satellite bandwidth, respectively.

10. The apparatus of claim 9, wherein the bursty data is non-voice data with bursty characteristics.

11. The apparatus of claim 9, wherein the one or more processors are configured to share the satellite bandwidth by dynamically sharing the satellite bandwidth to transmit the bursty data from the multiple sites using a demand assigned technique.

12. The apparatus of claim 11, wherein the demand assigned technique includes assignment of time slots and/or frequency bands in the satellite bandwidth to the multiple sites for transmitting the bursty data using the satellite bandwidth.

13. The apparatus of claim 12, wherein the demand assigned technique further includes adjustment of the time slot and/or frequency band in the satellite bandwidth assigned to a cell site, from among the multiple sites, in response to traffic needs of the cell site.

14. The apparatus of claim 8, further comprising:
a controller at each site which separates the bursty data and the non-bursty data for transmission terrestrially and by satellite, respectively.
